(19) United States
(12) Patent Application Publication
(10) Pub. No.: US 2010/0063873 A1
(43) Pub. Date: Mar. 11, 2010

(54) Method for providing creator-centric region on displays, devices, and social networks where content owners can define rights and creating a novel rights and content repositor

(75) Inventor: Elliot McGucken, Malibu, CA (US)

Correspondence Address: DR. ELLIOT MCGUCKEN, 23852 PCH, #971, MALIBU, CA, 90265, US

(73) Assignee: ELLIOT MCGUCKEN, MALIBU, CA (US)

(21) Appl. No.: 12/283,109

(22) Filed: Sep. 8, 2008

(51) Int. Cl. G06Q 30/00; G06Q 10/00

(52) U.S. Cl. 705/14.4; 705/26; 705/1; 705/14.73; 705/14.64

(57) ABSTRACT

Many tools exist for creating applications for social networks, phones, and other entities, and this invention affords owners full control of their content in a common, trusted window in foreign contexts, as provided for in the US Constitution. Content owners are afforded a window/region in arenas including web pages, social networks, handhelds, and phones, wherein they can protect and profit from content. Social networks are generally socialist networks wherein creators are deemed to have no value as individuals, but when aggregated with millions of others, they are monetized by corporations. This negative mindset has fostered unprofitable social networks which deny owners their Natural Rights to protect and profit from their creations. Disclosed is a novel method for creating a content market-space built upon universal windows/regions which support creators' rights, which fosters a superior social network for content owners, and an invaluable database and repository of rights and content.

### CROSS-REFERENCE TO RELATED APPLICATIONS

This application claims the benefit of provisional patent Ser. No. ______ filed Sep. 8, 2007 by the present inventor.

This application claims the benefit of patent application Ser. No. 20070106551 filed Sep. 19, 2006 by the present inventor, patent application Ser. No. 20070156594 filed Jan. 3, 2007 by the present inventor, patent application Ser. No. 20070255965 filed Apr. 15, 2007 by the present inventor, patent application Ser. No. 20080162287 filed Dec. 30, 2007 by the present inventor, and patent application Ser. No. ______ filed Jul. 11, 2008 by the present inventor.

### FEDERALLY SPONSORED RESEARCH

Not Applicable

### SEQUENCE LISTING OR PROGRAM

Not Applicable

### FIELD OF THE INVENTION

This current invention pertains to artists and their Natural Rights to protect and profit form their content, and more particularly to a novel region on web pages, social networks, mobile devices, phones, and other gear, entities, and contexts where media is downloaded and consumed, where said novel region, residing in a foreign context, becomes a place known for affording artists full control of their media and creations, and compensating them fairly and maximally, in manners controlled by the content owners.

### SUMMARY/BRIEF DESCRIPTION OF INVENTION

This present invention will foster a novel space in this universe—a parallel universe, so to speak—wherein the artists and creators are afforded the rights that allow them to protect and profit from their creations.

This current invention pertains to artists and their Natural Rights to protect and profit form their content, and more particularly to a novel region/domain on web pages, social networks, mobile devices, phones, and other gear, entities, and contexts where media is downloaded and consumed, where said novel region, residing in a foreign context, becomes a place known for affording artists full control of their media and creations, and compensating them fairly and maximally, in manners controlled by the content owners. This novel region/domain will give rise to a novel universe, and the novel region/domains on phones, handhelds, and windows in social networks will become portals to a brave new world wherein artists, such as the Beatles and Rolling stones might protect and profit from their work, as well as Dobie Grey, Kid Rock, and Uncle Kracker: http://www.youtube.com/watch?v=dzbjEXBcIYU. Maybe music, which benefited from the Constitution, which was born by brave, rugged souls fighting for freedom such as Jefferson, Jesus, and Socrates, is not enough to oversee the rights of music. Perhaps the source of rights protection comes from that deeper source—that lone, brave cowboy with his 45 Revolver, and the present invention proposes that every musician, artist, and creator be afforded a 45 Revolver—a mechanism and means for protecting and profiting from their content. The 45 Revolver will allow artists and inventors to define their rights, before this invention takes over, and provides them with a trusted region in foreign contexts/windows including social networks, web browsers, handhelds, media devices, and phones.

The current invention also pertains to social networks and social networking, and more particularly to a method for creating a profitable social network, via populating multiple platforms and handheld devices with a unique rights-centric region controlled by a plurality of applications, all which have the common origin where the artists or owners defined their rights and prices. The present invention could be used to foster a brand new social network, by first populating other social networks and foreign contexts with windows and regions wherein the artists/creators enjoy full rights management. The present invention includes a method that would begin by offering creators and artists and musicians full rights as well as a system and method for placing a window or defining a rights-centric region on other social networks and on devices such as the iphone and gphone, as well as in a plurality of foreign contexts, wherein they can control full rights to the content in the window or region, including access to and control of DRM, ecommerce, advertising, and other entities.

This present invention will foster a novel space in this universe—a parallel universe, so to speak, such as 45space/45domain/45region/45ranch—wherein the artists and creators are afforded the rights that allow them to protect and profit from their creations.

To begin with, every person, song, film, or entity (450) could be associated with a mastercode which would define the basic rights, including MASHUP SPECS, PRICE, USES, TYPE OF ADS, TYPES OF DEVICES, NETWORKS, NAME, ACCOUNT, PREFERRED, and PAYMENT. A result and consequence of this present invention would be the invaluable repository of rights definitions and its associated content and owners, which would provide a searchable database of content and rights definitions—an invaluable entity! Such a database could eventually replace google, as unlike google, it will allow rights definitions, and it will compensate artists and creators as they see fit, when their content is spidered, indexed, served, copied, mashed up, or utilized in any manner. A most valuable commercial ramification of the present invention would be the repository of rights definitions and its associated content and owners.

### BACKGROUND OF INVENTION

This invention is the missing key to the internet actualizing its full potential—it is the key to the next renaissances in the arts and technology that shall realize a cultural renaissance alongside the internet's full potential to maximize the creators' profits. The present invention will foster a brand representing artists' rights, wherein artists receive the lions' share of the profits from their creations, when said creations are displayed and served through novel region in foreign contexts. As production and distribution costs tumble, and as DRM is ultimately a commodity and algorithm, the artists hold the cards. The artists and creators are the soul of the internet, and one cannot commodify soul, but with tragic consequences. The ball is in the court, and they get to own the next shot. As social (socialist) networks prove less-profitable than originally supposed, and as they grew upon the backs of the content industries they cannibalized, new opportunities are presenting themselves to better serve artists and creators, which in turn will better serve consumers.

The internet has failed to live up to its greater potential of empowering and enriching artists. The internet was supposed to eliminate the middleman who tapped into artist's profits—instead it eliminated artist's profits. The internet was supposed to allow artists and creators new ways to distribute their content—to protect and profit from it; but instead, it has allowed them new ways to give their content away fro free, while Larry Lessig et al. tells them that they ought to sell t-shirts, as youtube is keeping it's $1.6 billion, and won't be offering DRM any time soon—DRM which allows the artist to protect and profit from their content, without some middelman corporation insisting that it must be given away for free so that said corporation can 1) aggregate it, 2) build a brand around it, 3) slap advertising on it, and 4) serve it from their proprietary platform while flying their proprietary logo, while growing their proprietary bank accounts. I understand that we live in postmodern times, where words mean nothing and the Constitution has been deconstructed so as to profit the elite, but yet, something in me—call it crazy—yet hopes and dreams.

I yet hope and dream of a day whence artists will be afforded the right to protect and profit from their content. When academics will man up and do their job in representing man's classical, natural, exalted, rights, for the lawyers probably never will. I dream of a day whence artists will profit each and every time their content is viewed, downloaded, or copied, just as the aggregators and telecoms and lawyers profit form this. Youtube and Myspace will still be able to use the art—the only difference is that they will have to share the wealth, while providing additional opportunities to the artists to protect and profit from their content. Yes—I am dreaming of a day when the little guy gets to keep his home, and the government bails him out instead of the massive corporations like Fannae Mae and Freddie Mac, who also get the little guys' home, pensions, and savings via the inflation tax. I am dreaming of a day where this country is once again exalted by great men, and the small-town artist gets to share in the vast wealth that could be—that will be—created in inventions such as this one. The empire if far too bankrupt, far too gone, many will contend; but yet, Rome lived on in our Constitution, and its classical precepts can rise again.

### PRIOR ART BACKGROUND AND ADVANTAGES OF CURRENT INVENTION

Whereas record labels once ripped artists off, today's Myspace™, Facebook™, and Youtube™, which live by artists, filmmakers, and musicians, pay them very, very little if anything at all. Nor do they provide a full suite of management tools for the artists, including DRM, watermarking, syndication, and ecommerce, as discussed in earlier patent applications by Dr. Elliot McGucken. The advantages of this current invention extend the advantages of previous innovations made by Dr. Elliot McGucken. This application claims the benefit of patent application Ser. No. 20070106551 filed Sep. 19, 2006 by the present inventor, patent application Ser. No. 20070156594 filed Jan. 3, 2007 by the present inventor, patent application Ser. No. 20070255965 filed Apr. 15, 2007 by the present inventor, and patent application Ser. No. 20080162287 filed Dec. 30, 2007 by the present inventor.

Kid Rock weighs in on the failures of the post-internet music industry and digital music revolution in a recent Wired blog article—http://blog.wired.com/music/2008/06/kid-rock-boycot.html:

“The digital music revolution has been compromised, according to Kid Rock, because digital music stores and record labels still manage to hoard the lion's share of music revenue.

Kid advises fans to download his music for free from P2P services, although he himself doesn't have to. “I don't steal things,” he told the BBC. “I'm rich.” As for everyone else, he says, “Download it illegally, I don't care. I want you to hear my music so I can play live.”

Rock's tirade was apparently precipitated by a request from his record label, Warner Music Group's Atlantic Records, that he publicly denounce file sharing. His response: “Wait a second, you've been stealing from the artists for years. Now you want me to stand up for you?” Ouch.

It seems there's no one way that artists are responding to the opportunities and challenges presented by the internet. It's official now: They're all over the map when it comes to downloads, DRM, file sharing and the rest of it, no longer offering the same rationales for completely different conclusions.”—http://blog.wired.com/music/2008/06/kid-rock-boycot.html:

This present invention will remedy this “Tower of Babel” situation and become a unifying force, fostering a novel space in this universe—a parallel universe, so to speak, such as 45space/45domain/45region/45ranch—wherein the artists and creators are afforded the rights that allow them to protect and profit from their creations. Kid Rock continues in http://blog.wired.com/music/2008/06/kid-rock-boycot.html:

“iTunes takes the money, the record company takes the money, and they don't give it to the artists,” added the country rock rapper. Instead, he says, the internet offers a “great opportunity for everyone to be treated fairly, for the consumer to get a fair price, for the artist to be paid fairly, for the record companies to make some money.”

This makes a lot of sense, and it's the sort of thing that the digital music optimists among us have been saying for years. However, Rock expands on the idea, positing that anyone who needs something should just take it: “I don't mind people stealing my music, that's fine. But I think they should steal everything. You know how much money the oil companies have? If you need some gas, just go fill your tank (up) and drive off, they're not going to miss it.”

Kid Rock's iTunes boycott is in full effect. As of right now, none of his Warner-era albums are available on iTunes, where only his rarely heard debut—1990's Grits Sandwiches for Breakfast on Zomba Recordings—is available (clicking the link spawns iTunes).”—http://blog.wired.com/music/2008/06/kid-rock-boycot.html

And it is exactly this opportunity that this present invention aims to help realize. Rock says, “the internet offers a “great opportunity for everyone to be treated fairly, for the consumer to get a fair price, for the artist to be paid fairly, for the record companies to make some money.”” And this current invention, as well as 22nets and the 45 Revolver and other inventions by Dr. E aim to help the artists and creators protect and profit form their creations.

Current social (socialist) networks and the dominant psychology of the tech-legal Matrix has lead to generally unprofitable social networks that are eroding the infrastructure of content creation. The technological revolutions have been vastly advantageous to artists seeking production and distribution, but the big-money tech-legal Matrix is seeking to transfer all the artists' wealth to themselves. The internet has yet to realize its full, greater potential—it has yet to empower the artist, innovator, and creator to the extent it is capable of doing.

Record companies have had a long history of screwing the artist and paying them very little, and now social networks have improved upon this, by paying the artist even less or nothing at all, while denying them fundamental, Constitutional, and natural opportunities for DRM. The big-money tech-legal Matrix has turned against DRM, as DRM cuts them out of the picture, allowing the artist to sell directly to the end user—a system the current invention would favor and foster. DRM that served the artists would make it difficult for the big-money tech-legal Matrix to socialize the arts. It would make it difficult for universities with billion-dollar endowments to tell artists that they have no rights, while aggregating millions of them, slapping advertising on everything, and creating an ultimately profitless, guady contraption or corporation such as a myspace or facebook, which are attempting to drive the price of art down to zero, so that there is no value in protecting one's natural rights, pressuring artists to give everything away for free for the supposed greater good of the world, and the exaltation of the massive corporations' bottom lines.

Opportunity abounds to reunite artists with their Constitutional rights. The Constitution authorized the congress “to promote the progress of science and useful arts, by securing, for limited times to authors and inventors the exclusive right to their respective writings and discoveries.” It also authorized the congress alone the right to coin money, but that has been taken over by a private banking cartel which naturally fosters an entire society that works to transfer wealth to the elite and their lawyers. Lawyers are natural socialists, as everyone must earn a living somehow, and when lawyers have to choose between the Constitution and protecting artists rights, or seizing artist's property and profiting from the inflation tax, they grant themselves tenure and turn against property rights—other peoples' property rights, that is. Above the Supreme Court is engraved Equal Justice Under Law, and that is exactly the premise, which was gifted to us the classical Judeo Christian Heritage, that they are trying to eradicate, as they deconstruct the great books and classics. The tenured mob also has a general hatred for the living poet, prophet, and philosopher, and thus in addition to demolishing the Constitution and the Great Books, they are attacking the rights of the living artist and author, not only to transfer all the creators' wealth to themselves, but also for the pure enjoyment of bringing the classical, creative soul on down. For like the Whale in Moby Dick, they are not content to go down in this declining, bankrupt empire, without dragging the arts with them: “A sky-hawk that tauntingly had followed the main-truck downwards from its natural home among the stars, pecking at the flag, and incommoding Tashtego there; this bird now chanced to intercept its broad fluttering wing between the hammer and the wood; and simultaneously feeling that etherial thrill, the submerged savage beneath, in his death-gasp, kept his hammer frozen there; and so the bird of heaven, with archangelic shrieks, and his imperial beak thrust upwards, and his whole captive form folded in the flag of Ahab, went down with his ship, which, like Satan, would not sink to hell till she had dragged a living part of heaven along with her, and helmeted herself with it.”

But the Constitution shall rise again. “Now small fowls flew screaming over the yet yawning gulf; a sullen white surf beat against its steep sides; then all collapsed, and the great shroud of the sea rolled on as it rolled five thousand years ago.” The rising generation shall someday know technology that allows creators to protect and profit from their content, eliminating the myriad of shape-shifting middlemen, who taxed and traduced the artist as record labels, and now pay them absolutely nothing as social networks, detesting DRM as it would allow the artist to sell directly to the consumer, thusly detracting from their ability to slap advertising on every sonnet and symphony, on every friendship and thought. But I maintain, as sure as night follows day, that art is worth buying and paying for, and like any property, or even moreso than any property, it is worth protecting, for what is a society without a soul? What will society become when all the epics are deconstructed so that snarky socialists can hand one-another awards in tax and tuition funded ceremonies? Those systems which incorporate DRM, those systems which naturally serve the Constitution, those systems which allow artists to protect and profit from their content shall trump today's technology, and become tomorrow's platforms.

### PRIOR ART

Social networks are currently generally unprofitable and less profitable than they were originally promised to be. A recent article in the MIT Technology Review reports: “Social Networking Is Not a Business. Web 2.0—the dream of the user-built, user-centered, user-run Internet—has delivered on just about every promise except profit. Will its most prominent example, social networking, ever make any money? Many Users, Few Dollars: Social networking is the fastest-growing activity on Web 2.0—the shorthand term for the new user-centered Internet, where everyone publicly modifies everyone else's work, whether it's an encyclopedia entry or a photo album. The growth of social networking is astonishing, and it has spread to sites of all sizes, which are increasingly intertwined as platforms open (see “Who Owns Your Friends?”). Even small players are soaring . . . . Nevertheless, the sites seem largely incapable of generating revenues commensurate with their popularity.”—http://www.technologyreview.com/Biztech/20922/

Imagine a Facebook® or Myspace® application that allowed creators to protect and profit from their content. Imagine that this facebook/myspace application was tied into a backend application that provided the user with a full suite of rights-management tools. Imagine that the backend application was itself a social network. Over time, artists and creators would first sign aboard the social network with the rights management tools, before deploying the window of rights management on foreign social networks such as myspace and facebook, or any other social network.

While Steven Jobs has advocated getting rid of DRM, he always kept his DRM DRM'd, exhibiting vast hipocracy. He never shared fairplay with artists and developers, and thus actually encouraged the piracy of songs not listed for sale in iTunes. However, iTunes is finally getting called out.

Wired reports—http://blog.wired.com/business/2008/09/its-an-itunes-s.html

“It's a different story now. The iTunes backlash has gained serious momentum. There is no shortage of iTunes critics or competitors now, including TV networks, cable providers, retailers and movie studios, many of which are forging online strategies that conspicuously exclude Apple.

“Frankly, I'm not really sure why [the backlash] didn't start sooner,” says KC Blake, director of business development at the University of Southern California's Entertainment Technology Center. “It's not like anyone is making a ton of money off iTunes.”

Among the most recent anti-iTunes developments: Amazon rolled out an ad-free television and movie streaming service yesterday that is both Mac- and PC-friendly (unlike Netflix' streaming service). The online retailer also launched a downloading service for rentals or purchase through Sony's Bravia internet video device. Over the weekend, Comcast rolled out a video download store for movie purchases and rentals, roughly a year after it rolled out a video streaming service.

And the Comcasts and Amazons of the world are probably the least of Apple's worries. Content providers and copyright holders are working furiously to come up with a mainstream alternative to iTunes. Sony is reportedly developing its own digital media platform—which would run on open-source digital-rights management software. NBC ditched iTunes last year, opting instead to launch a digital platform with Fox. And increasing numbers of artists are keeping their music off iTunes. (Kid Rock famously urged listeners to download his music illegally, but his “Rock 'n Roll Jesus” album sold remarkably well, nonetheless.)

The main beef studios have with iTunes is that while Apple controls the pricing, format and experience, they get nothing out of it but a share of the revenue.

“[The studios] want to decide what's being offered and how it's being delivered,” says Blake.

Another key reason for the studios' frantic desperation to find or form an alternative platform: The video business isn't toast yet, while the music business is, well, almost toast. And while Apple's iTunes has become a default music app for iPod owners, it isn't an obvious default home for video.

“I don't think iTunes has a huge competitive advantage [over others] just because it's been around awhile. Apple may have an advantage because so many people use iTunes to store their music, but I don't think Apple can maintain that lead in video,” says Blake. “Based on our research, we know that people will watch stuff on iTunes on their laptops, but there aren't a whole lot of people using their iPods to watch videos. It's just not a good experience.”—http://www.stuff.co.nz/stuff/4678324a4500.html:

So it is that the video business may be headed the same way as the music business, where artists work for free, where the infrastructure is destroyed, where no longer shall we have The Good The Bad and The Ugly, Star Wars, The Beatles, Pink Floyd, and The Rolling Stones, but instead we'll have ten million myspace bands and a billion youtube producers none of whom are paid. For when everyone's an artist, nobody's an artist, and the big-money legal-tech Matrix enjoys this, as they generally detest true indie artists, and what better way to destroy them and take all their profits as society, deprived of its exalted soul, declines into debt and debauchery? As the legal-tech Matrix sits close to the ultimate central planning entity—the Federal Reserve—which manufactures the money that can buy the free market, they generally oppose Dante who favored artists over usurers in The Inferno. They are very well paid to proclaim a love for the arts and artists, while they do everything in their power to destroy them.

Kid Rock elaborates on the advantages of looking beyond itunes in Stuff—http://www.stuff.co.nz/stuff/4678324a4500.html:

### ‘Steal Everything,’ Rock Says

Rock has been an outspoken critic not only of track downloading but internet piracy. In a “smartass” public service announcement he recently advised people to steal everything.

“I understand people are pilfering songs—it's just a song,” Rock told Billboard during a recent pit stop at a Nashville tequila bar.

“I'm not going to complain, Tommy Hilfiger's rich, too, but you can't walk into a department store and steal a pair of jeans. I don't care, steal my songs if you want, but let's level the playing field.

“You know how much money the oil companies have? You think they're going to miss it if you fill up your gas tank and drive off?”

Eschewing iTunes also proves a point, Rock adds. “I tell people in my organisation, ‘Do not ever come up to me and say, “This is what everyone's doing and how they're doing it.” Don't ever give me that lame-ass bullshit’,” he says.

“As soon as someone says, ‘You have to be on iTunes . . . they're the No. 1 retailer’ . . . . I don't have to.”

In Rock's view, iTunes is the McDonald's of music.

“It's extremely convenient, no question about it. I think Apple is one of the greatest companies in America,” he says.

“But just because McDonald's is convenient doesn't mean that people won't make reservations or wait in line to eat elsewhere if the food is what they want, or the atmosphere. That's proven every day.”

“We get so caught up in technology and ease (of downloading a single) . . . there's nothing wrong with listening to a whole record from start to finish,” Levitan says.

“Being kind of Captain America like I consider myself, I wanted to go give (other countries) what I think is the true voice of the people, not just New York and Los Angeles. Maybe be an ambassador of goodwill in some way through the music.”—http://www.stuff.co.nz/stuff/4678324a4500.html

So it is that it's OK to steal a song, or a million of them, but not an ipod. Many argue that a song is just digital information, and by copying it, one is not actually stealing it, as the original owner still has a copy. Well, why not copy information from bank accounts? Why not just add a zero at the end of one's account. This has taken no money from anyone, and has merely accomplished what the Federal Reserve does every day. And that's what it comes down to. Their lawyers have declared war on the artists and creators, and thus it is OK to steal from artists as long as it helps the tech industry sell bandwidth and devices. Artsists and creators are to be used to build socialist networks and sell advertising iPods, but never compensated. If they want to get paid, they ought sell t-shirts, they are told, as only the tech-legal Matrix has the right to profit from their ultimately worthless creations, which must be given freely, for the greater good of society and civilization.

### FURTHER OBJECTS AND ADVANTAGES OF INVENTION

And this patent and innovative approach will favor the bold—those willing to embrace classical idealism while going up against the massive mob and their lawyer kings, just as the 300 Spartans did in 300—just as William Wallace went up against the Scottish Nobles in Braveheart. The method for building a superior system disclosed in this invention includes the following:
1) develop technology that allows the existence of a window in a foreign social network, such as myspace, facebook, ning, bebo, or kickapps, wherein the artist controls full rights, and brand this as the 45revolver or 45surf or 45network or 45space. OpenSocial may be used, along with other tools and APIs.
2) develop technology that allows the existence of a window in a foreign device, such as an iphone or gphone, wherein the artist controls full rights, and brand this as the 45revolver or 45surf or 45mobile.
3) develop technology that allows the existence of a window on a TV, wherein the artist controls full rights, and brand this as the 45revolver or 45surf or 45mobile.
4) have all the above windows link back to a common social network built upon a suite of digital rights management/watermarking/ecommerce/syndication/populating/master control panel tools and digital rights management marketplace disclosed in earlier patent applications by Dr. Elliot McGucken including the 45 Revolver patent, Dodge city DRM Marketplace. Over time, this social network will be the starting place for all artists, content creators, and musicians.

### FURTHER PRIOR ART IN RELATED FIELD

Social networks have failed miserably to provide artists with technologies affording simple DRM and rights management, and they are thus failing to create profits, both for themselves and artists. Ideas have consequences, and today's social networks, developed in the shadow of and bullied by anti-artist-rights lawyers and aggregators, have inherited the double-speak ideologies, where the artist no longer has strong rights to their content, but only the social networks, who also have teams of lawyers to defend their patents, brands, and trademarks. When it comes to the next generation of technological networks, platforms, and tools for artists, it does not appear that Chris Dewolf nor Tom Anderson nor Rupert Murdoch nor the Faceboiok dude are going to realize it.

A recent Fast Company article reports, “With Facebook surging, cofounders Chris DeWolfe and Tom Anderson have gone back to their roots—music, pop culture, and a proven cash-flow ad model—to spur a next phase of growth. Will that be enough for boss Rupert Murdoch?”—http://www.fastcompany.com/magazine/128/myspace-the-sequel.html

And judging by the picture of Chris and Tom, it does not appear that they are man enough to integrate digital rights management and Constitutional Principles into their technology. While they are very pretty, it does not appear they are man enough to ride into town for the showdown, face down the snarky mob and elite lawyers, and deliver God's thundering Justice from the ends of their revolvers. They appear more concerned about their hair as opposed to the classical, epic soul and the Constitution. But such is the way of the world, and mark my work, Hollywood is longing for the return of the classic, epic Western. The present invention will allow the rugged artist, creator, and entrepreneur to call the pretty-boys' socialist bluff.

Throughout the entire article, http://www.fastcompany.com/magazine/128/myspace-the-sequel.html, neither artists rights nor the Constitution nor DRM are ever mentioned. And thus the spirit of this present invention goes against the prevailing expert opinion, while also providing a novel means and mechanism for virally piggy-backing upon existing social networks such as myspace and facebook with tools and technologies supporting a full suite of artist's rights, including DRM, ecommerce, and watermarking.

But the Fast Company article does report on revenue shortfalls: “Both founders are full of pride for the business they have built—and are still building. They see the recent revenue-growth shortfall as merely a distraction from the real news: the absolute performance MySpace delivers. “There are only three or four companies in the world that have our type of reach,” says DeWolfe. FIM may have missed its whopping, Murdoch->mandated $1 billion revenue target in June, but the unspoken defense is that MySpace alone contributed the vast majority of the $900 million that did come in. That's three times even the most optimistic estimates of Facebook's performance (although as a private company, Facebook does not release financials).”—http://www.fastcompany.com/magazine/128/myspace-the-sequel.html

### Empowering Creators Across all Networks and Devices

The present invention will allow artists to protect and profit from their content, reaping maximum and superior rewards, in branded windows served across all social networks, resting upon Opensocial and other APIs, including APIs for the iphone, gphone, and digital TVS. A common API means you have less to learn to build for multiple websites. http://code.google.com/apis/opensocial/ explains, “OpenSocial is currently being developed by a broad set of members of the web community. The ultimate goal is for any social website to be able to implement the API and host 3rd party social applications. There are many websites implementing OpenSocial, including Engage.com, Friendster, hi5, Hyves, imeem, LinkedIn, MySpace, Ning, Oracle, orkut, Plaxo, Salesforce.com, Six Apart, Tianji, Viadeo, and XING.” The current invention would also allow windows on iphones, itunes, and gphones, where when the end user consumes or purchases the artists' content, they know the artist is being compensated maximally and failry. If iphone, itunes, or the gphone, or any social network refuses to play with manifestations of the current invention, that is OK—they can continue on in the old world, dominated by the profiteering off yesterday's hits and the destruction of the infrastructure that bolstered them. But they cannot do this forever, and sooner or later, where the artists, musicians, directors, producers, filmmakers and owners gravitate, the consumers will gravitate. All the lawyers in the world cannot keep the Constitution at bay forever. All the tenured priests can not deconstruct those Natural Rights that the Creator granted every creator.

A small team of developers, skilled in the art of programming and web development, could realize this invention.

### A Brand New Currency

Imagine the gold45—a brand new currency based on entities including digital content, pageviews, number of friends, number of downloads, and more. For instance, suppose a user comes along and spends ten hours acquiring a thousand friends on a social network—surely there in some value in this, and perhaps they would receive 100 gold45's. They would then be able to cash these 100 gold45's in for dollars, or euros, or buy a digital download or two. The great thing about the gold45 monetary unit is that it could be pegged to the gold standard, so that it could be traded for actual gold. This would stem the temptation of the fiat masters to keep on printing money and funding lawyers to privatize all of the artist's profits and socialize the risk. While the art's center and circumference is Truth, the fiat-masters' center and circumference is deception, as they create money from thin air and charge interest on it, while the artist creates actual wealth and content from their very own blood, sweat, and tears. We live in a day and age where the Constitution is assaulted on all fronts, where the artists are denied their Natural Rights, and where a private banking cartel is granted the ultimate power of creating money for nothing, and where vast institutions that privatize profits and socialize risk are bailed out, while individuals lose their homes and their Natural rights. Is it no wonder that powered by this fundamental form of postmodernism—the very father of saying one thing while believing another—academia has become filed with the ironic firemen from Fahrenheit 911, who exist to burn the books and counter the Constitution, instead of to support it? They are given mini-fiatocracies for placing God over mammon, and thus even supposedly Christian schools erase the Word and replace it with a Stock Ticker.

But imagine a brand new currency based in the super-network afforded by this present invention where those who build networks earn currency that allows then to purchase content, and where those who create content are allowed to protect and profit from their content in a currency that time and tide cannot corrupt and thieves cannot steal.

Here are some quotes on Gold which support the present invention and this novel form of currency which would provide a superior store of value for artists and others:

“Thinking to get at once all the gold the goose could give, he killed it and opened it only to find—nothing.”—Aesop

“Money, which represents the prose of life, and which is hardly spoken of in parlors without an apology, is, in its effects and laws, as beautiful as roses.”—Ralph Waldo Emerson quotes

“In the absence of the gold standard, there is no way to protect savings from confiscation through inflation . . . . This is the shabby secret of the welfare statists' tirades against gold. Deficit spending is simply a scheme for the confiscation of wealth. Gold stands in the way of this insidious process. It stands as a protector of property rights. If one grasps this, one has no difficulty in understanding the statists' antagonism toward the gold standard.”—Alan Greenspan

“Gold still represents the ultimate form of payment in the world.”—Alan Greenspan

“Gold is not necessary. I have no interest in gold. We will build a solid state, without an ounce of gold behind it. Anyone who sells above the set prices, let him be marched off to a concentration camp. That's the bastion of money.”—Adolf Hitler

“The real menace of our Republic is the invisible government which like a giant octopus sprawls its slimy legs over our cities states and nation. At the head is a small group of banking houses generally referred to as ‘international bankers.’ This little coterie . . . run our government for their own selfish ends. It operates under cover of a self-created screen . . . [and] seizes . . . our executive officers . . . legislative bodies . . . schools . . . courts . . . newspapers and every agency created for the public protection.”—John F. Hylan

“Woe unto you, ye blind guides, which say, Whosoever shall swear by the temple, it is nothing; but whosoever shall swear by the gold of the temple, he is a debtor!”—Jesus of Nazareth

“The Federal Reserve (Banks) are one of the most corrupt institutions the world has ever seen. There is not a man within the sound of my voice who does not know that this Nation is run by the International Bankers.”—Louis McFadden

“The government of the world was [Cecil] Rhodes' simple desire.”—Sarah Gertrude Millin

“Gold is still the ultimate store of wealth. It's the world's only true money. And there isn't much of it to go around. All of it ever mined would fit into a small building—a 56 foot cube. The annual world production would fit into a 14 foot cube, roughly the size of an ordinary living room. If each Chinese citizen were to buy just one ounce, it would take up the annual supply for the next 200 years.”—Mark Nestmann quotes

“We have come to be one of the worst ruled, one of the most completely controlled and dominated Governments in the world.”—Woodrow Wilson

“If the American people ever allow private banks to control the issue of their currency, first by inflation, then by deflation, the banks . . . will deprive the people of all property until their children wake-up homeless on the continent their fathers conquered . . . . The issuing power should be taken from the banks and restored to the people, to whom it properly belongs . . . . The modern theory of the perpetuation of debt has drenched the earth with blood, and crushed its inhabitants under burdens ever accumulating.”—Thomas Jefferson

“History records that the money changers have used every form of abuse, intrigue, deceit, and violent means possible to maintain their control over governments by controlling money and its issuance.”—James Madison

“If congress has the right under the Constitution to issue paper money, it was given them to use themselves, not to be delegated to individuals or corporations.”—Andrew Jackson

“The Government should create, issue, and circulate all the currency and credits needed to satisfy the spending power of the Government and the buying power of consumers. By the adoption of these principles, the taxpayers will be saved immense sums of interest. Money will cease to be master and become the servant of humanity.”—Abraham Lincoln

“Issue of currency should be lodged with the government and be protected from domination by Wall Street. We are opposed to . . . provisions [which] would place our currency and credit system in private hands.”—Theodore Roosevelt

“I am a most unhappy man. I have unwittingly ruined my country. A great industrial nation is controlled by its system of credit. Our system of credit is concentrated. The growth of the nation, therefore, and all our activities are in the hands of a few men. We have come to be one of the worst ruled, one of the most completely controlled and dominated Governments in the civilized world no longer a Government by free opinion, no longer a Government by conviction and the vote of the majority, but a Government by the opinion and duress of a small group of dominant men.”—Woodrow Wilson

“The real truth of the matter is, as you and I know, that a financial element in the large centers has owned the government ever since the days of Andrew Jackson . . . ”—Franklin D. Roosevelt (in a letter to Colonel House, dated Nov. 21, 1933)

And so, by and by, one begins to see why the fiatcoracy funds the destruction of artist's Natural Rights in their universities and think tanks. Even modern so-called libertarians are against property rights for artists, as are conservatives and liberals, as everyone lusts after the riches granted by selling one's soul to the fundamental irony of our times, funded by a fiat currency—the ability to create false value where there is no intrinsic value, via fiat, or postmodemism, or groupthink, and then convert that false value into tangible assets, via placing students or home buyers or patients in massive debt, or some other means. The only price that is paid is one's soul, and that's why the soulless rise to the top. In his book The Road to Serfdom, which considers the inevitable tragedies of central planning, F. A. Hayek has two chapters entitled The End of Truth and Why The Worst Get on Top. Well, as fiat currency is the ultimate form of central planning, so it is that the worst rise to the top, as those with the least amount of soul and character are the best suited to the lying that fiatocracies subsist upon. This invention will be countered by ten thousand idiots who do not even realize that they are useful idiots—mere little fiatcrats in the larger regime—but yet, like the words of Jefferson, Horner, and Jesus, the soul of this invention will prevail.

### OBJECTS AND ADVANTAGES OF INVENTION OVER PRIOR ART

The present invention improves upon the current situation by affording the artist/creator a region on popular devices, social networks, and within webpages where they are the master of their own domain. The present invention improves upon the current situation by affording the artist/creator a region on popular devices, social networks, and within webpages where they are known to be the master of their own domain. 45domain/45my/45ranch is a region wherein they can take full control of their content, and protect and profit from it in a superior manner. The artist controls the DRM options in this region/window, and everyone shall know it, adding value to the region by the fact that people know that they are supporting the artist whenever they interact with said region, whether they are viewing content there, purchasing merchandise, or embedding said region in their web page. The artist controls the ecommerce options in this region/window, selling t-shirts and DVDs if they so choose. The artist controls the advertising options in this region/window, whereby they are compensated for the advertising. This control of one's creations, which naturally echoes our Natural Rights, will exalt the artist, affording them new commercial opportunities, as well as a system and method for building superior social networks.

Kid Rock would have enjoyed the Founding Fathers' and Great Economists' views on property rights, and this patent reaches on back to the Great Minds of Western Freedom so as to deliver a superior technology, exalting the Spirit of Property Rights.

“If history could teach us anything, it would be that private property is inextricably linked with civilization.”—Ludwig Von Mises. The current invention would embody this principle, providing a novel blend of technology and principle that achieves the internet's fuller potential in allowing artists and creators to protect and profit from their creations.

“The right to life is the source of all rights—and the right to property is their only implementation. Without property rights, no other rights are possible. Since man has to sustain his life by his own effort, the man who has no right to the product of his effort has no means of sustaining his life. The man who produces while others dispose of his product is a slave.”—Ayn Rand. The current invention would embody this principle, providing an optimum, novel blend of technology and principle that achieves the internet's fuller potential in allowing artists and creators to protect and profit from their creations across all devices, social networks, browsers, and applications.

“God put raw materials and the forces of Nature at man's disposal. To gain possession of them, either one has to take pains, or one does not have to take pains . . . . If pains must be taken, . . . the satisfaction must go to the one who has taken the pains. This is the principle of property. Will anyone dare to say that a man should not be the owner of the pains he himself takes? . . . . Let him take care! That would mean glorifying slavery; for to say that certain men must render services that are not paid for, means that other men must receive services that they do not pay for, which is certainly slayery.”—Bastiat, In “Economic Harmonies”, chapter 8 (“Private Property and Common Wealth”): The current invention would embody this principle, providing a novel, optimum blend of technology and principle that achieves the internet's fuller potential in allowing artists and creators to protect and profit from their creations across all devices, social networks, browsers, and applications.

“Exchange is a natural right, like Property. Every citizen who has created or acquired a product, must have the option either to apply it immediately to his own usage, or to yield it to anyone, on the surface of the globe, who agrees to give him in exchange the object of his desire.”—Hayek, Inaugural Declaration to the Association for the Freedom of Exchanges. 1846 The current invention would embody this principle as no other current technology does, providing a novel combination of technology and principle that achieves the internet's fuller potential in allowing artists and creators to protect and profit from their creations across all devices, social networks, browsers, and applications.

Let men labor, exchange, learn, band together, act, and react upon one another, since in this way, according to the laws of Providence, there can result from their free and intelligent activity only order, harmony, progress, and all things that are good, and increasingly good, and still better, and better yet, to infinite degree.—Hayek, Economic Harmonies. Introduction: “To the youth of France”. 1850.

Bastiat explains modern social networks such as myspace and facebook with: “Socialist writers base their various theories upon one common hypothesis: they divide mankind into two parts. People in general—with the exception of the writer himself—form the first group. The writer, all alone, forms the second and most important group. Surely this is the weirdest and the most conceited notion that ever entered a human brain!

“In fact these writers begin by supposing that people have within themselves no means of discernment; no motivation to action. They assume that people are inert matter, passive particles, motionless atoms, at best a kind of vegetation indifferent to its own manner of existence. They assume that people are susceptible to being shaped, by the will and hand of another person—into an infinite variety of forms, more or less symmetrical, artistic, and perfected . . . .

“These socialists writers look upon people in the same manner that the gardener views his trees. Just as the gardener capriciously shapes the trees into pyramids, parasols, cubes, vases, fans, and other forms, just so does the socialist writer whimsically shape human beings into groups, series, centers, sub-centers, honeycombs, and other variations. And just as the gardener needs axes, pruning hooks, saws, and shears to shape his trees, just so does the socialist writer need the force that he can find only in law to shape human beings. For this purpose, he devises tariff laws, tax laws, relief laws, and school laws.

“Socialists look upon people as raw material to be formed into social combinations. This is so true that, if by chance, the socialists have any doubts about the success of these combinations, they will demand that a small portion of mankind be set aside to experiment upon . . . . And one socialist leader has been known seriously to demand that the Constituent Assembly give him a small district with all its inhabitants, to try his experiments upon.”—Bastiat, The Law. 1850.

And so we see that Bastiat describes how Lessig et al view youtube and myspace, and why the content industry is suffering as Andrew Keen elaborates on. The present invention, by affording property rights, will foster a renaissance in content creation—something that is sorely needed after all these years of deconstruction of the Great Books and Classics so as to transform America into a bankrupt, soulless empire. The artist's alone can save the American Soul with a classic, epic renaissance, and this invention shall allow them to do so. And who can argue that there is no value in the epic soul, but for Satan and socialists?

“The man who does no more than physical labor consumes the material value equivalent of his own contribution to the process of production, and leaves no further value, neither for himself, nor for others. But the man who produces an idea in any field of rational endeavor—the man who discovers new knowledge—is the permanent benefactor of humanity . . . the man who creates a new invention receives but a small percentage of his value in terms of material payment, no matter what fortune he makes—Ayn Rand. “Atlas Shrugged”. 1959. The present invention will support this individual creator.

“When we have developed a technique or discovered a gift of Nature, some new fertility in the soil, or some new application of the laws of the physical universe, the profit goes to us momentarily, fleetingly, as it is just to get some recompense, and useful to encourage further efforts. Then our advantage slips through our hands, despite our attempts to retain it; it ceases to be personal, becomes social, and falls for ever in the realm of the free for all. And, while we contribute to the enjoyment of mankind through the progress we have made, we enjoy ourselves the progress that all other men have accomplished.” Frederic Bastiat. “Economic Harmonies”. Chapter 12: The Two Mottoes. 1850. The current invention would embody this principle, providing an optimum blend of technology and principle that achieves the internet's fuller potential in allowing artists and creators to protect and profit from their creations across all devices, social networks, browsers, and applications. This invention would serve the creator and owner of content, and thus end consumer of content, in a superior manner.

“Existence, faculties, assimilation—in other words, personality, liberty, property—that is what man is.” Frederic Bastiat. “The Law”. 1850 The current invention would embody this principle, providing an optimum and novel combination of technology and principle that achieves the internet's fuller potential in allowing artists and creators to protect and profit from their creations across all devices, social networks, browsers, and applications.

“If government have a right of demanding ad libitum and of taxing us themselves to the full amount of their demand if we do not comply with it, this would leave us without anything we can call property”—Thomas Jefferson (American 3rd US President (1801-09). Author of the Declaration of Independence. 1762-1826). The current invention would embody this principle, providing an optimum, novel blend and combination of technology and principle that achieves the internet's fuller potential in allowing artists and creators to protect and profit from their creations across all devices, social networks, browsers, and applications. This invention would serve the artist, and thus end consumer of content, in a superior manner.

“The Right of property is the guardian of every other Right, and to deprive the people of this, is in fact to deprive them of their Liberty”—Arthur Lee. Artists have no fundamental property rights without access to DRM, which Steve Jobs will never share or offer for free, even though he thinks artists ought move away from encrypting their music, films, and creations. The current invention would embody Lee's principle, providing an optimized, novel combination of technology and principle that achieves the internet's fuller potential in allowing artists and creators to protect and profit from their creations across all devices, social networks, browsers, and applications.

“Among the natural rights of the colonists are these: First a right to life, secondly to liberty, and thirdly to property; together with the right to defend them in the best manner they can”—Samuel Adams. The current invention would embody Adams' principle, providing a novel blend of technology and principle that achieves the internet's fuller potential in allowing artists and creators to protect and profit from their creations across all devices, social networks, browsers, and applications.

“Property is surely a right of mankind as real as liberty.”—John Adams (American 2nd US President (1797-1801), 1735-1826). The current invention would embody this principle, providing an optimum blend of technology and principle that achieves the internet's fuller potential in allowing artists and creators to protect and profit from their creations across all devices, social networks, browsers, and applications.

“Just as man can't exist without his body, so no rights can exist without the right to translate one's rights into reality, to think, to work and keep the results, which means: the right of property.”—Ayn Rand quotes (Russian born American Writer and Novelist, 1905-1982) The current invention would embody this principle, providing an optimum blend of technology and principle that achieves the internet's fuller potential in allowing artists and creators to protect and profit from their creations across all devices, social networks, browsers, and applications. This invention would serve the artist, and thus end consumer of content, in a superior manner.

“Next to the right of liberty, the right of property is the most important individual right guaranteed by the Constitution and the one which, united with that of personal liberty, has contributed more to the growth of civilization than any other institution established by the human race.”—William Howard Taft quotes (American 27th US President (1909-13). 1857-1930) The current invention would embody this principle, providing a novel blend of technology and principle that achieves the internet's and www's fuller potential of allowing artists and creators to protect and profit from their creations across all devices, social networks, browsers, and applications.

“Every man has a property in his own person. This nobody has a right to, but himself.” John Locke quotes (English Philosopher who made great contributions in studies of politics, government and psychology. 1632-1704). The current invention would embody this principle, providing an optimum blend of technology and principle that achieves the internet's fuller potential in allowing artists and creators to protect and profit from their creations across all devices, social networks, browsers, and applications. This invention would serve the artist, and thus end consumer of content, in a superior manner.

“No power on earth has a right to take our property from us without our consent.”—John Jay quotes (American, 1745-1829) The current invention would embody this principle, providing an optimum combination of technology and principle that achieves the internet's and www's fuller potential in allowing artists and creators to protect and profit from their creations across all devices, social networks, browsers, and applications. This invention would serve the creator and owner of content, and thus end consumer of content, in a superior manner.

Well, hows comes Ben Bernanke is never told to sell t-shirts like artists are? How come Bear Stearns, Fannie Mae, and Freddie Mac don't have to sell t-shirts? How come Larry Lessig isn't told to sell t-shirts to make money, instead of receiving donations from Google for his foundation that disparages individual artists' rights for “the greater good of humaity”?

Paul Stanley of KISS weighs in on the recording industry, piracy, and merchandising in Billboard—http://www.billboard.biz/bbbiz/search/article_display.jsp?vnu_content_id=1003671447

“The record industry is in such a mess. I called for what it was when college kids first started download music for free—that they were crooks. I told every record label I spoke with that they just lit the fuse to their own bomb that was going to explode from under them and put them on the street.

“There is nothing in me that wants to go in there and do new music. How are you going to deliver it? How are you going to get paid for it if people can just get it for free? I will be putting out a Gene Simmons box set called “Monster”—a collection of 150 unreleased songs. KISS will have another box set of unreleased music in the next year.

“The record industry doesn't have a f*cking clue how to make money. It's only their fault for letting foxes get into the henhouse and then wondering why there's no eggs or chickens. Every little college kid, every freshly-scrubbed little kid's face should have been sued off the face of the earth. They should have taken their houses and cars and nipped it right there in the beginning. Those kids are putting 100,000 to a million people out of work. How can you pick on them? They've got freckles. That's a crook. He may as well be wearing a bandit's mask.

“Doesn't affect me. But imagine being a new band with dreams of getting on stage and putting out your own record. Forget it.”—Paul Stanley in http://www.billboard.biz/bbbiz/search/article_display.jsp?vnu_content_id=1003671447

And so it is that Paul Stanley tells it like it is. Lessig, Jobs, Youtube, Myspace, Google, et al have built their monetary empires on the decline of infrastructure and classical rights that rising artists could once count on. Some people will say, “but hey! Look at Radiohead! Look at Trent Reznor! They give it away for free, or let you pay what you want, and still make money!” But they forget that these artists came up from the traditional infrastructure. The Billboard article continues:

“Billboard: But some artist like Radiohead and Trent Reznor are trying to find a new business model.

Paul Stanley: That doesn't count. You can't pick on one person as an exception. And that's not a business model that works. I open a store and say “Come on in and pay whatever you want.” Are you on f*cking crack? Do you really believe that's a business model that works?

Billboard: So what if music just becomes free and artists make their living off of touring and merchandise?

Paul Stanley Well therein lies the most stupid mistake anybody can make. The most important part is the music. Without that, why would you care? Even the idea that you're considering giving the music away for free makes it easier to give it away for free. The only reason why gold is expensive is because we all agree that it is. There's no real use for it, except we all agree and abide by the idea that gold costs a certain amount per ounce. As soon as you give people the choice to deviate from it, you have chaos and anarchy. And that's what going on.”—Paul Stanley in http://www.billboard.biz/bbbiz/search/article_display.jsp?vnu_content_id=1003671447

Imagine if doctors and lawyers gave their services away for free and had to make their living from selling t-shirts. Imagine if the Federal Reserve gave away the money it printed for free, and had to make their living off of selling t-shirts with Ben Bernanke's face on the front and a helicopter on the back, instead of charging billions upon billions in interest on that which they created from thin air, as they privatize the profits and socialize the risk, just like Myspace/Youtube/traditional record labels. So it is that we inhabit a dying empire where artists are denied their Constitutional rights, while the bankers/lawyers profit from defiling the Constitution by printing money from thin air—a power that the Founders granted the Congress, not a private banking cartel. The bankers can make billions off of interest on money created from thin air, but artists aren't even allowed to make a couple bucks off their creations and a lifetime of blood, sweat, and tears. “How all occasions do inform against me,” spake Hamlet.

Ludwig Von Mises wrote about the dark side of fiat currencies, which above all else must protect the elite lawyers and bankers, to whom all the creators and artists wealth must be transferred, as was the case with Youtube, where the gaffers, musicians, filmmakers, screenwriters, directors, actors, producers, and artists got paid nothing when youtube was sold for $1.6 billion. When rights are ignored and subverted, civility and society decline.

### FURTHER ADVANTAGES OVER PRIOR ART

Sites such as Revver.com, blip.tv, and metacafe.com allow one to upload videos and embed videos in web pages, wherein the videos are oft served along with advertising, which compensates the creator. But one cannot upload photography nor music alone, and one cannot sell video, nor offer DRM'd music nor video through the little Revver window, nor blip.tv window, nor metacafe window, nor any form of ecommerce. Youtube now places google ads in frames surrounding videos. PC Pro reported, “Google reserves YouTube DRM for partners only 7:18 AM, Monday 19 Feb. 2000: The commercial content and mainstream media sector is up in arms with video sharing site YouTube over its plans to offer digital rights management and other anti-piracy tools to companies it has signed distribution deals with. According to sources close to the discussions, YouTube, bought last year by Google, will implement technology to help media companies identify pirated videos uploaded by users. However, the tools are currently being offered as part of broader negotiations on licensing deals, they said. The move contrasts with YouTube's biggest rival, social networking web site, MySpace, owned by News Corporation. MySpace stated it would offer its own version of copyright protection services for free. YouTube's ‘proposition that they will only protect copyrighted content if there's a business deal in place is unacceptable,’ said a spokesman for Viacom, owner of MTV and Paramount Pictures. One media industry source likened YouTube's policy to a ‘mafia shakedown.’”—http://www.pcpro.co.uk/news/105118/google-reserves-youtube-drm-for-partners-only.html Snocap allows one to sell songs across various social networks, mostly via unprotected mp3s. iPhones allow one to buy itunes and video form the itunes store, and zune can consume music from the Zune store.

The present invention would contain a platform that would provide a window on all networks and devices including all the above services. As more and more devices come forth with platforms for developers, such as the Iphone™ and Gphone™, and as more and more social networks emerge with platforms for developers, such as Facebook™ and myspace, orkut, and others which will adapt the OpenSocial API, the future success of the present invention described herein becomes more and more apparent. Imagine a trusted window or region across all these devices which signals to the user—“hey—this is the place where I can purchase content or view content while compensating the artist and creator!” Imagine a trusted window or regions which allowed the creator to get their content out across multiple platforms while maintaining full control of their content.

This present invention combines numerous features in existing technologies, while providing brand new features, resulting in a novel window or region that becomes known as the creators and consumer best bet for protecting, profiting from, and enjoying content.

This invention would offer the first step in revolutionizing and standardizing the content industry, but it will only work if, like Vanguard, the artists and creators are maximally compensated. The steps to taking over the content industry and laying down the law so as to favor the artists and creators would begin with this invention, as well as others filed by Dr. Elliot McGucken, and are as follows:
1. Offer a full suite of digital rights management tools, syndication tools, ecommerce tools, and watermarking tools to artists and creators, via methods afforded by Dr. E's 45REVOLVER invention.
2. Here is where the present invention comes in: create easy code that would allow the 45my/45domain window/region with all the 45REVOLVER rights to be displayed across all devices, platforms, phones, browsers, and social networks.
3. Over time the window/region becomes a trusted portal or window into premium content, artist compensation, and exaltation.

### BRIEF DESCRIPTION OF DRAWINGS

FIG. 1 illustrates how the present invention would come to dominate all social networks and devices, as a trusted region wherein the artist is known to control their content, including, but not limited to, setting prices, adding ads, encrypting content, DRMing content, and more. Such a system is likely to be railed against by the tech-legal Matrix and their fiat faculty, as they will at first believe that it will lower their profits, while in actuality, it will actually afford profitable businesses and social networks on down the line which better compensate the artist and all parties involved. But socialists generally prefer the quick buck that is gained via taxation, as opposed to the long-term wealth generated by freedom, liberty, and law.

FIG. 2 illustrates how the present invention would foster a brand new currency for artists, creators, and builders of social networks. The currency could be pegged to gold, so as to give the artists a fair advantage over the tech-legal Matrix which is subverting their natural, Constitutional Rights so as to aggregate all their creations without compensating them, while also hitting them with the inflation tax.

FIG. 3 illustrates some of the multitude of options creators/artists would be afforded, and which would be represented on regions across a multitude of platforms and devices.

FIG. 4 illustrates how different participants in a production may be tagged and thus automatically compensated for the use or viewing of the media, be it a song, clip, film, or other form of media.

FIG. 5 shows a method for displaying advertising on a photograph or any digital content, wherein the owner of the photograph or digital content can designate the location of the ad as well as the movement of the ad, if any.

### DETAILED DESCRIPTION OF POSSIBLE EMBODIMENTS OF INVENTION

The heart and soul of this invention are brought to life in a greater context, summarized with:

1. Offer a full suite of digital rights management tools, syndication tools, ecommerce tools, and watermarking tools to artists and creators, via methods afforded by Dr. E's 45REVOLVER invention.
2. Here is where the present invention comes in: create easy code that would allow the 45my/45domain/45live window/region with all the 45REVOLVER rights to be displayed across all devices, platforms, phones, browsers, and social networks.
3. Over time the window/region becomes a trusted portal or window into premium content, artist compensation, and exaltation.

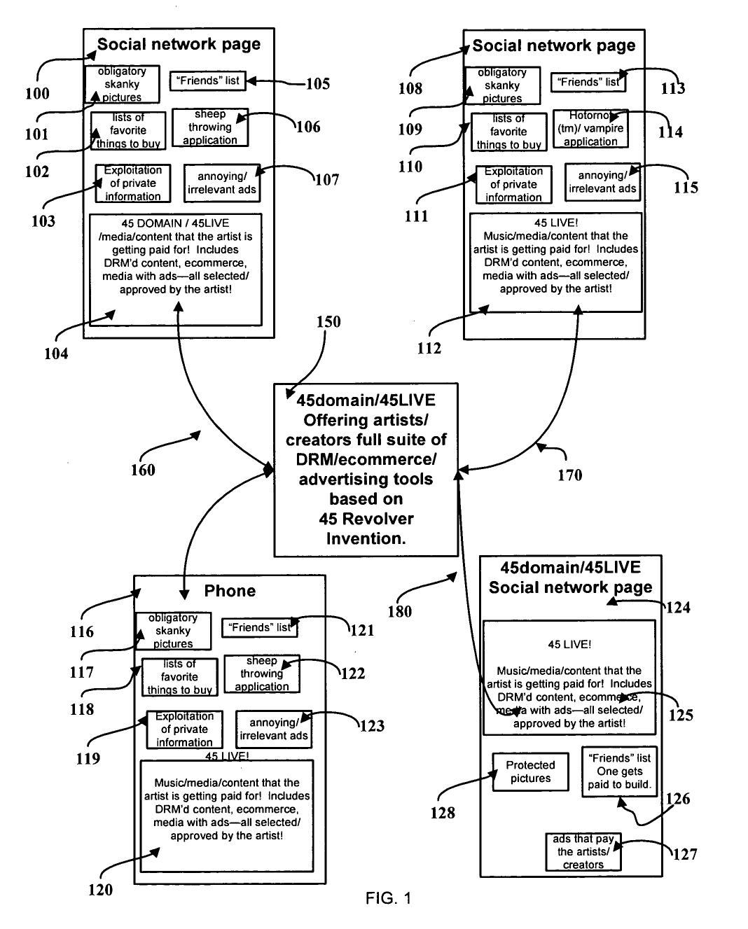

FIG. 1 illustrates how the present invention would come to dominate all social networks and devices, as a trusted region wherein the artist is known to control their content, including, but not limited to, setting prices, adding ads, encrypting content, DRMing content, and more. Such a system is likely to be railed against by the tech-legal Matrix and their fiat faculty, as they will at first believe that it will lower their profits, while in actuality, it will actually afford profitable businesses and social networks on down the line which better compensate the artist and all parties involved. But socialists generally prefer the quick buck that is gained via taxation, as opposed to the long-term wealth generated by freedom, liberty, and law.

In many ways window or region (104) represents a Trojan horse, containing freedom, liberty, and law, in the form of digital righst management for the owner and creator, which can be placed on multiple platforms via a couple lines of javascipt or html or other methods. Region (104) will contain and operate upon a creator-centric vision of the universe, as opposed to the dominant aggregator-centric view of the universe.

Regions (104) is the primary, simplest manifestation of this current invention, and from it a powerful brand can spring. Region (104), which hooks directly to a full suite or rights—management tools (150) based on Dr. Elliot McGucken's 45 Revolver invention. Region (104) may be branded as 45my or 45domain or 45ranch or 45live, or in some other way that comes to symbolize full author and creator control—the natural control that the Declaration of Independence suggests and the technology affords. Region (104) may appear across a multitude of devices and platforms, including, but not limited to phones (116), various social networks (100), (108), and even a novel social network (124) where greater artist and author and owner rights and profits are the rule, not the exception.

Region (104) may appear in many contexts such as on phones (116) where it appears as (120) or other social networks where it appears as (112) and (125).

Wherever the Region (104) is manifested, be it on phones (116) where it appears as (120) or other social networks where it appears as (112) and (125), it is connected to a central control panel (150) wherein all rights are managed in manners disclosed in previous inventions of Dr. Elliot McGucken. DRM, ecommerce, tracking, syndication, cash-flow, and all forms of communications may be handled by web-services, including REST, SOAP, and other mechanisms (150), (160), and (170).

100 shows a typical social network with the obligatory skanky pictures (101), the lists of favorite things to buy (102) or things bought recently, the exploitation of private information widget (103), some sheep-throwing application (106), and annoying/irrelevant/flashing ads (107). Phones are staring to like more and more like this (116), and the present invention will offer a breath of fresh air, leading to its own, enhanced social network (124), where profits are made not by commoditizing friendships, spying on shopping habits, and denying artists their natural rights, but by supporting artists and their natural rights, and providing a trusted platform for protecting, profiting form, and consuming content.

Thus the heart and soul of this invention is to be found within future windows and regions on foreign social networks and on foreign devices, where artists rights are maximally supported and celebrated. Existing social networks or phones may reject these windows of freedom and liberty, of peaceful commerce, but that will only make them more valuable, and over time those devices which reject the 45windows/45live regions of peace and prosperity will be disadvantaged. Steven Jobs used the superior tech/interface paradigm to beat the music industry at its own game. Youtube used the superior legal machinations, DMC loopholes, popular tech interface to build its empire, largely off of content for which the artist and creator was never compensated. And the next revolution will be lead by those systems and innovations which lead with superior rights management for artists and innovators. This present invention discloses an early step—the definition and propagation of a window/region where artists' rights are exalted and managed by the artists'/owners of the content, and where they receive a lion's share of the profits. By allowing artists and creators to populate the internet with such a window, a multitude of commercial opportunities will ensue, and a rising tide lifts all boats.

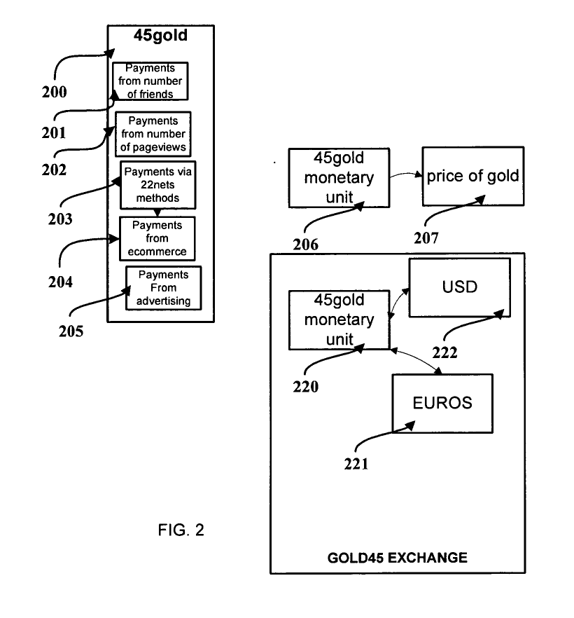

FIG. 2 illustrates how the present invention would foster a brand new currency for artists, creators, and builders of social networks. The currency could be pegged to gold, so as to give the artists a fair advantage over the tech-legal Matrix which is subverting their natural, Constitutional Rights so as to aggregate all their creations without compensating them, while also hitting them with the inflation tax. A member of the network could be compensated on multiple levels and for multiple entities including but not limited to: (201) payments for the number of friends they aggregate (202) payment for number of pagevies (203) payments form methods disclosed in the 22nets invention by Dr. Elliot McGucken, (204) payments from ecommerce, and (205) payments from advertising. The 45gold monetary unit could be linked directly (206) to the price of gold (207) by various means, so that the artists' and creators' wealth is preserved. A market may emerge, where entities including but not limited to pageviews, friends, and content are ascribed different values on different networks shown in FIG. 1. Artists, creators, and users will naturally gravitate towards the systems that gave them the best deals, and the great thing is, it would all be backed by gold. Nowhere does nay social network nor content marketplace utilize a novel currency, nor do any use a novel currency pegged to gold. The 45gold unit (220) could be exchanged for other currencies including the US Dollar (222) or Euros (221) by a mechanism that tracked exchange rates and a common exchange system.

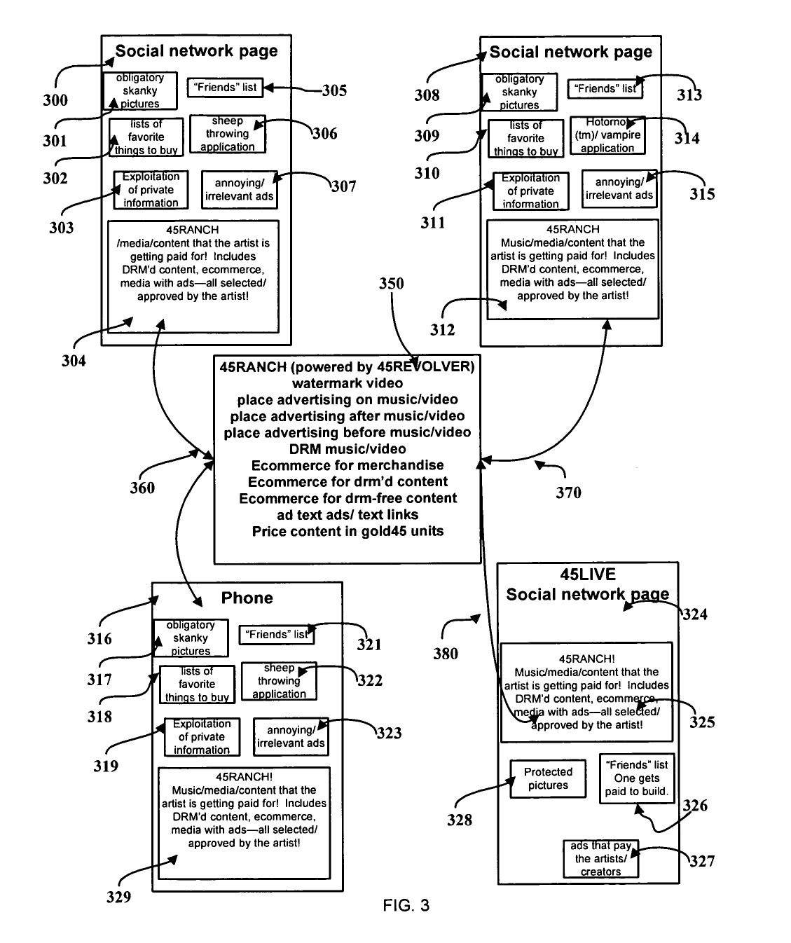

FIG. 3 illustrates some of the multitude of options creators/artists would be afforded, and which would be represented on regions across a multitude of platforms and devices. FIG. 3 shows how Dr. Elliot McGucken's 45 Revolver innovation might be better utilized, optimized, and popularized. FIG. 3 is best viewed in the context of FIG. 1 and earlier patent applications filed by Dr. Elliot McGucken, where the properties of the 45 Revolver are disclosed. This application claims the benefit of patent application Ser. No. 20070106551 filed Sep. 19, 2006 by the present inventor, patent application Ser. No. 20070156594 filed Jan. 3, 2007 by the present inventor, patent application Ser. No. 20070255965 filed Apr. 15, 2007 by the present inventor, and patent application Ser. No. 20080162287 filed Dec. 30, 2007 by the present inventor, as well as the Ideas Have consequences Video Game Engine filed Jul. 11, 2008 by the present inventor.

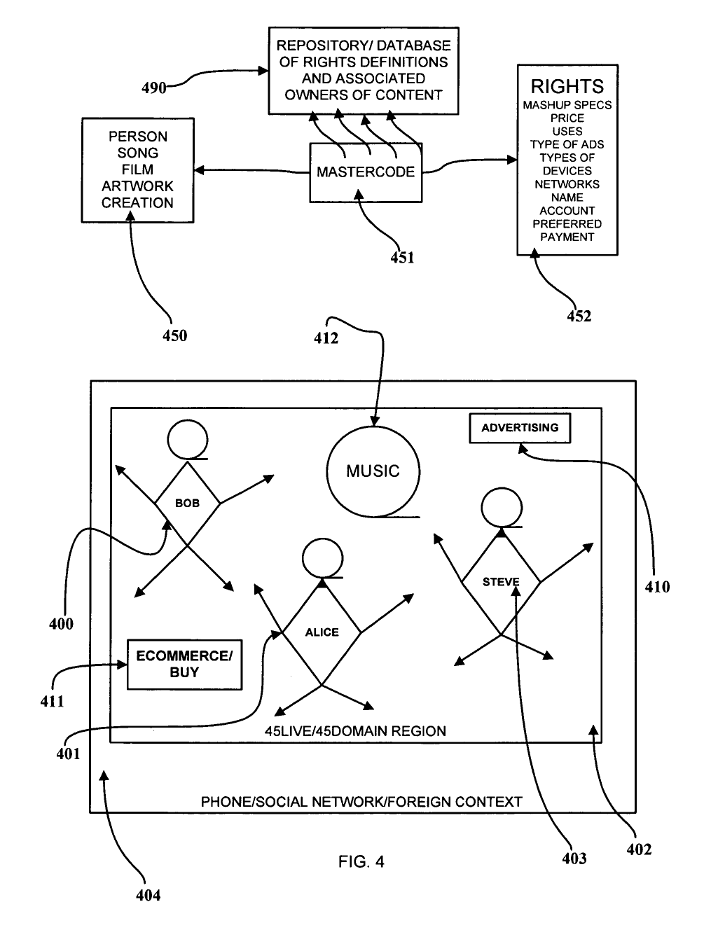

FIG. 4 illustrates how different participants in a production may be tagged and thus automatically compensated for the use or viewing of the media, be it a song, clip, film, or other form of media. Imagine if an artist got paid every time his or her song was played. Imagine if you got paid every time your photo was used on facebook or myspace or on google or in any other venu. Imagine if someone came across a video and tagged the music, and thus the musicians started getting paid. The novel 45live or 45domain region described in this invention would provide the technology to afford all this.

To begin with, every person, song, film, or entity (450) could be associated with a mastercode (451) which would define the basic rights (452), including MASHUP SPECS, PRICE, USES, TYPE OF ADS, TYPES OF DEVICES, NETWORKS, NAME, ACCOUNT, PREFERRED, and PAYMENT. A result and consequence of this present invention would be the invaluable repository (490) of rights definitions and its associated content and owners, which would provide a searchable database of content and rights definitions—an invaluable entity! Such a database could eventually replace google, as unlike google, it will allow rights definitions, and it will compensate artists and creators as they see fit, when their content is spidered, indexed, served, copied, mashed up, or utilized in any manner. A most valuable commercial ramification of the present invention would be the repository (490) of rights definitions and its associated content and owners.

Imagine that Alice (401), Bob (400), and Steve (403) partake in a production. They can either tag themselves with their 45domain master code that compensates them whenever they appear throughout the 45space/45network/45domain, or other people can tag them. They can set the percentage of their participation and/or the percentage of the profits they should receive. Whenever the media is consumed in the 45live/45domain region (403), bought, or purchased, they will be compensated. Producers, directors, cameramen, and others may also associate themselves or their master code with the content. The music (412) may be from an artist who is a member of the 45space, in which case the musician will also be compensated. Every object, person, piece of music, and such can be tagged with a master tag which defines its usage rights and compensation levels. Any advertising revenues or ecommerce revenues will be split across those who participated in the creation, in proportion to their participation which can be reflected in the tagging of the media. This basic idea can be developed in multiple directions, but it basically comes down to a universal network which separates itself form what is out there my compensating artists and actors. Mashups could be considered in a new context wherein creators, whose content is mashed up, are compensated proportionally to the use of their content in the mashups. DRM could be a liberating force in this context, as it would allow creators to set their content free, and the DRM'd content could be used in new creations that respected the DRM and compensated the creator fairly. This in turn could lead to a brand new class of inventions that leveraged DRM so as to provide a more exalted realm for creating and sharing content, wherein artists and creators actually get paid. DRM could also be unlocked by an ad—if the ad is viewed, than the DRM key is provided and the content can be viewed.

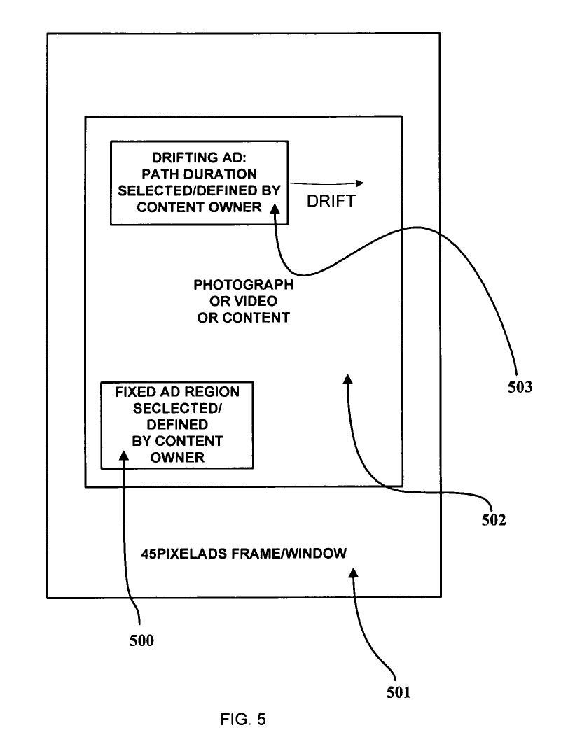

FIG. 5 Shows a method for displaying advertising on a photograph or any digital content, wherein the owner of the photograph or digital content can designate the location of the ad as well as the movement of the ad, if any. A piece of digital content (502) exists in a frame or region or window exalted in this invention (501). As the owner of the content (502) has rights to it, they can designate pixels where ads can be displayed (500) and/or select a moving advertisement (503) defining such attributes as its drift direction and duration. Such an innovation could lead to novel forms of advertising, more effective forms of advertising, and more control for owners of content to define ads. The content owner's power to place ads has a lot of advantages, including their ability to designate the least important, or most important parts of their content for ad placement, as well as their ability to select a complimentary ad size and designate the number of pixels for the ad to be placed over their content.

### IMPLEMENTING THE INVENTION

The disclosed invention may be readily built by a small team skilled in the art of web development, along with off-the-shelf social networking software and DRM tools, and the philosophy, methods, knowledge, and software disclosed in other cross-referenced patent applications made by Dr. Elliot McGucken. This application claims the benefit of patent application Ser. No. 20070106551 filed Sep. 19, 2006 by the present inventor, patent application Ser. No. 20070156594 filed Jan. 3, 2007 by the present inventor, patent application Ser. No. 20070255965 filed Apr. 15, 2007 by the present inventor, and patent application Ser. No. 20080162287 filed Dec. 30, 2007 by the present inventor.

### FURTHER OBJECTS AND ADVANTAGES OF INVENTION

The current invention proposes building a brand centered about a region or window on a web page or social networking site that is definitively known by and for its support of artists' and creators' rights. Imagine seeing a frame on a myspace site that said 45rock, or 45domain, or 45revolver, or 45surf™ and knowing that that meant that when you bought a song from the artist, or when you viewed content, the artist was compensated in a fair and maximal manner that the artist had control over. 45rock would be tied into a backend system based on earlier patent applications by Dr. Elliot McGucken, allowing artists to protect and profit form their creations.

The current invention pertains to a method for creating profitable social networks centered around respecting the artists' and creators' rights. Accompanying the rise of social networking has been the rise of applications residing upon social networks, and the present invention proposes an application which allows the user full control and rights to the content in the application, as provided for in the US Constitution. Social networks are generally socialist networks wherein the creator is told that they have no value on their own, but when aggregated with millions of others, they can be sold to a major corporation, whereupon the wealth of their labor is transferred to the Wall Street aggregators. However, social networks are generally unprofitable, and furthermore, they deny users an opportunity to protect and profit from their creations. The present invention will allow content creators/owners a window on social networks wherein they manage their rights, while building a backend master social network that becomes the choice of serious content creators and owners, and which will be far more profitable than today's socialist networks.

Imagine a system which allowed the creator, artist, or talent to protect and profit from their content. 45my/45domain/45revolver defines a region on a webpage that belongs wholly to the creator/user, meaning that they get to define the content within the said region, and protect and profit from said content. All ads served within the region compensate the owner of the region.

Although ads on popular social networks including facebook and myspace do not compensate the user, ads within 45my/45ranch do compensate the user/owner of content in the 45my region.

Myspace and facebook and other social networks may ban this current invention, as they cannot stand the thought of artists profiting form their works. Myspace and facebook and other social networks may ban this current invention as the Lessig/Murdoch corporate/state machine cannot stand the thought of artists protecting their works. Myspace and facebook and other social networks may ban this current invention, as they can't even stand the thought of creators and artists watermarking their works. Myspace and facebook and other social networks may ban this current invention manifested as 45my/45live, and that's why 45my/45live may also feed into or act or as or become its own exalted social network. For instance, if one clicks on the 45my region in a preferred embodiment of the invention, they may be lead to the 45my page on the 45my social network. And on that page, ads will be served which do actually compensate the user, content/creator. So it is that by offering a novel way to protect and profit from content, and to disseminate content throughout networks such as facebook and myspace, 45my will empower artists, musicians, models, and creators as never before.

The great thing about the 45my region is that it will become a brand known for supporting artists and creators' rights.

The 45my/45domain/45ranch/45live social network will also serve as a stand-alone social network, where the advertising on the page will compensate the owner of the page and the builder of the content. Furthermore, the 45my region or 45my frame may also exist in whole on the 45my social network. Even though myspace and facebook may ban the 45my frame or region from their sites, as shown in the figure above, while the 54my frame/region will exist in its entirety on the 45my social network site, shown in the figure below.

Entities which may appear within the 45my region include:

1) banner ads

2) drmed files

3) ecommerce

4) affiliate sales

5) video, music, text: drm'd and non-drmed

6) text ads

7) contextual ads

8) pixel ads, as described below, which are pixels superimposed on pictures.

9) pricing art/creations/likeness in units of 45gold

At the 45my™ site, an interface will be provided to allow the creator to track their revenues, ad sales, clicks, and more. The interface will allow them to define their rights, as provided for in earlier patents filed by Dr. Elliot McGucken, including the 45 Revolver and 22nets, and other related patent applications filed by the inventor. A brand new currency, 45gold, may be incorporated.

The novelty of this present invention is that it provides a frame/region where the content can be displayed and protected on sites throughout the web, in a manner such that the creator can profit.

Imagine 45 pixelads: novel system, method, and apparatus for delivering ads superimposed over photographs and pictures on the web, whereby ads may drift across pictures and pages, or they may be stationary, and allowing photographers and owners of said pictures to protect and profiting from content. System, method, and apparatus for providing creator-centric region where rights may be defined and content may be protected and profited from, and for promoting and profiting from content throughout the internet. Photographers and creators and owners and filmmakers may designate the placement of the ads and the motion of the ads on the picture.

45Pixelads™ represent regions of photographs that can be sold as ads. A photograph can have associated with it a maximum number of pixel ads (P1, P2, P3), the maximum/minimum size of ad, and the general placement of the ad, such as relegated to the corners, edges, middle, or elsewhere. Each photograph may become an image map, whereupon when the pixel is clicked on, the advertiser is visited. The pixels may be text ads or graphical in nature, or some combination of both. Both text ads and single ads may appear in the picture. A single pixel ad may correspond to an entire a picture, and clicking anywhere on the entire picture will lead to the advertiser who owns the ad, and pixel ads may come in various shapes, sizes, and pixel counts, and consist of pictures and/or text. Pixelads may have sounds associated with them.

Also, the ad may be embedded beforehand or superimposed over the picture during the presentation to the end user, but in either case, mousing over the ad may lead to a popup window with further information. Clicking on the ad may lead to a new website or a popup window, relevant and related to the pixelads.

The pixel ads can be of various shapes and sizes, such as 10×0 pixels or 20×20 pixels, or some other size. A various number of pixel ads may be included in each picture, such as one, two, three, or more pixel ads; and either a maximum number of pixel ads or maximum area may be set.

Furthermore, the pixel ads could be mobile, meaning that they could scroll across the screen and drift across pictures or photographs, and even off of the photographs, into the page.

45Pixelads™ may also appear in conjunction with music, videos, games, and other media. For instance, the same frame which hosts pictures on the 45my social network based on the 22nets social network, or any other social network such as myspace or facebook, could display pictures, videos, and music, all with the 45pixelads functionality.

The photographs may exist in frames and be placed on myspace pages and other social networking sites. The 45Pixelad frame may come to define a brand that empowers photographers, artists, and others. The 45my frame may serve as a 45pixelad frame, and the 45my home social network may contain a rights interface, tracking interface, and content owner/creator control panel, as described by Dr. Elliot McGucken in this and other previous inventions. Such a control panel would allow the creator to upload content, define their rights, and elect to have pixel ads served over the content.

Such a system represents a superior and hitherto unseen form of advertising. There are millions of photographs throughout the web, as well as on myspace and other social networks, and none of them have 45Pixelads™. Furthermore, pictures are often the most looked at, first looked at, and focus of attention on web pages. 45Pixelads™ should be highly successful, as it overlays pixel ads over the photography, pictures, art, and more.

When the ads are clicked, the url of the website that owns the ad is brought up in either the same browser or a new window.

An interface for setting rights, and other features, including watermarking, is described in earlier patents and provisional patents filed by Dr. Elliot McGucken. Such an interface, also incorporating the setting of the maximum number of pixel ads and other properties pertinent to the present 45Pixelads™ invention, could be used as a home port.

Again, social networks such as myspace and facebook may oppose 45Pixelads™, which could be delivered in a my45™ frame. But the my45™ site shall forever support the pixelads.

What is claimed is:

1) A system and method for creating a novel region or window in a foreign context including web browsers, social networks, phone displays, and other devices and entities wherein the content owner has full control of their digital rights in said regions or windows.

2) The method in claim 1 where said region offers the artist the options to sell DRMed versions of their work, display DRMed versions of their work, display their work along with advertising for which they are compensated, display their work for free, display watermarked versions of their work, and display their work as they see fit.

3) The method in claim 1 where said region offers the artist the ability to sell merchandise including but not limited to t-shirts, hats, and physical media.

4) The method in claim 1 where said region links back to a master social network wherein artists are afforded tools to protect, watermark, syndicate, share, sell, and profit from their content in a plurality of manners.

5) The method in claim 1 where said region links back to a master social network that allows the buying and selling of content with novel currency independent of established currencies.

6) The method in claim 1 where said region links back to a master social network that allows the buying and selling of content with novel currency pegged to the gold standard.

7) A system and method for creating a social network in which users, builders, artists, and creators are compensated in a novel currency.

8) The method in claim 7 where said social network allows users to upload and protect content and sell content in transactions wherein a novel currency is utilized.

9) The method in claim 7 where said social network compensates users for pageviews or media views in a novel currency, with which they may purchase content and merchandise or exchange for other currencies.

10) The method in claim 7 where said social network compensates users for building networks in a novel currency, with which they may purchase content and merchandise.

11) The method in claim 7 where said social network compensates users for advertising and ecommerce sold from their page in a novel currency, with which they may purchase content and merchandise or exchange it for other currencies.

12) The method of claim 7 wherein said novel currency is pegged to the gold standard.

13) The method of claim 7 wherein said novel currency may be exchanged for other currencies.

14) A method for establishing a master key and identity for content including likenesses and creations spanning all digital media, so that the owner or creator can define rights for said digital media, so that the owner or creator can be compensated throughout all uses of their property throughout the social network in claim 7, the regions in claim 1, and the entire novel space exalted in this invention.

15) The method in claim 14 where one is afforded a method for designating the proportionality of participation and profits that should go to various participants in a production, such as by tagging different actors, musicians, writers, music, art, and film so that their said master key can be tracked and the creators can be compensated.

16) The method in claim 14 where users define the rights of their creations when registering a master key, setting permissions for use and defining how they should be compensated.

17) The method in claim 14 where users are afforded digital rights management options and ecommerce options in defining the rights of their creations when registering a master key, and where they may set permissions for use of their content and define how they should be compensated.

18) The method in claim 14 where the master key and identity and associated content may be used in social networks, devices, and applications that registers with a central repository which maintains the master keys and their associated content affiliations and rights designations.

19) The method in claim 14 where a central searchable database and repository maintains the master keys and their associated content affiliations and rights designations.

20) The method in claim 14 married to the method in claim 1 wherein the method in claim 1 for creating a novel region or window in a foreign context including web browsers, social networks, phone displays, and other devices and entities wherein the content owner has full control of their digital rights in said regions or windows, when married to the ability to define rights in claim 14, results in an invaluable repository and database of rights definitions and content.
